(19) United States
(12) Patent Application Publication
(10) Pub. No.: US 2015/0254504 A1
(43) Pub. Date: Sep. 10, 2015

(54) EPULLTAB SYSTEM

(71) Applicant: MarketPro.net, LLC., Duluth, GA (US)

(72) Inventors: Jeffrey M. Brown, Longmont, CO (US); Michael Mayo Macke, Duluth, GA (US); Mark Cameron Nizdil, Duluth, GA (US)

(21) Appl. No.: 14/640,086

(22) Filed: Mar. 6, 2015

Related U.S. Application Data
(60) Provisional application No. 61/949,406, filed on Mar. 7, 2014.

(51) Int. Cl. G06K 9/00; G06K 7/00

(52) U.S. Cl. CPC G06K 9/00429; G06K 7/0095

(57) ABSTRACT

In one embodiment, a system comprising an epulltab comprising a win code, an encrypted code, and a bar code corresponding to the encrypted code; and a portal system comprising a first device at a first facility and a remote device coupled to the first device over a network, the remote device hosting a website, the first device providing a vendor interface to the website, the portal system configured to: receive the encrypted code or the bar code from the first facility; extract first information from the encrypted code or the bar code; compare at least a portion of the first information with a stored value; and determine whether to validate the epulltab based on the comparison.

### CROSS REFERENCE TO RELATED APPLICATION

This application claims the benefit of U.S. Provisional Application No. 61/949,406 filed Mar. 7, 2014, which is hereby incorporated by reference in its entirety.

### TECHNICAL FIELD

The present disclosure is generally related to gaming systems, and, more particularly, anti-fraud measures in gaming systems.

### BACKGROUND

Pulltabs are a popular, paper-based bingo derivative game. Every pulltab contains a minimal set of legally required symbology used to decode the winning value of the tab. A tab is by definition a paper based construct with a win code printed on a piece of paper, with another layer adhered to the top in order to obscure the code. To interact with the construct a customer (player) opens the tab thereby revealing a non-obvious set of symbols. The player then uses a grid of definitions (pay table) printed on the back of the tab in order to reveal the notional value of that unique tab. Generally, the player hands over the winning tab to the vendor, who provides a visual confirmation of the win and reimburses the player.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates an embodiment of an example epulltab.

FIG. 2 is a schematic diagram that illustrates an embodiment of an example epulltab system.

FIG. 3 is a schematic diagram that illustrates an embodiment of an example remote device that may be used in the epulltab system of FIG. 2.

FIG. 4 is a schematic diagram that illustrates plural random number generators that may be used in an embodiment of the remote device of FIG. 3.

FIGS. 5A-5C are schematic diagrams that illustrate mapping to coordinate space in an embodiment of an epulltab system.

FIG. 6 is a schematic diagram that illustrates an embodiment of an encryption mechanism used by an embodiment of the remote device of FIG. 3.

FIG. 7 is a schematic diagram that illustrates an embodiment of an example encryption mechanism used by an embodiment of the remote device of FIG. 3.

FIG. 8 is a schematic diagram that illustrates an embodiment of an example decryption mechanism used by an embodiment of the remote device of FIG. 3.

FIGS. 9A-9F are schematic diagrams that illustrate some example information corresponding to encrypted codes used in an embodiment of an epulltab system.

FIGS. 10A-10E are schematic diagrams that illustrates some example screens that may be used to monitor information or affect operations in an embodiment of an epulltab system.

FIG. 11 is a schematic diagram that illustrates an embodiment of a device that may be used at a vendor facility or elsewhere to redeem an epulltab.

FIG. 12 is a flow diagram that illustrates an embodiment of an epulltab method.

### DESCRIPTION OF EXAMPLE EMBODIMENTS

### Overview

In one embodiment, a system comprising an epulltab having a win code, an encrypted code, and a bar code corresponding to the encrypted code; and a portal system comprising a first device at a first facility and a remote device coupled to the first device over a network, the remote device hosting a website, the first device providing a vendor interface to the website, the portal system configured to: receive the encrypted code or the bar code from the first facility; extract first information from the encrypted code or the bar code; compare at least a portion of the first information with a stored value; and determine whether to validate the epulltab based on the comparison.

### DETAILED DESCRIPTION

Certain embodiments of an epulltab system and method are disclosed that extend the conventional pulltab game to a broader range of uses while providing anti-fraud measures to a game that conventionally relies for validation on a single visual inspection by a vendor whose facility hosts the pulltab game. In one embodiment, the epulltab system comprises a pulltab with conventional symbology as well as additional information including one or more encrypted codes and corresponding one or more bar codes (e.g., one or two dimensional codes) to enable validation and use in a plurality of machines or devices. Such a revised version of the pulltab is referred to herein as an epulltab. In some embodiments, the epulltab system further includes one or more devices that are used to validate the epulltab over a network (e.g., over a wide area network, such as the Internet), and other devices that may use the epulltab to initiate or advance a game running on the devices.

Digressing briefly, in existing systems, pulltabs are limited to a single use, whereby the customer compares the symbols unveiled by pulling an adhesive layer on the pulltab, compares the pattern of symbols to a pay table on the back of the pulltab, and upon recognition of a pattern that matches one of the winning patterns printed on the back of the pulltab, exchanges the pulltab with the vendor for validation and remuneration. That is, the validation involves a single visual inspection, with the risk, in today's age of advanced photo copying, with copies of fraudulent winning tabs. Further, today's pulltabs have limited use, and hence limited appeal. In contrast, certain embodiments of epulltab systems and methods provide for the secure exchange and validation of the epulltab, and extended use, whether with a winning pattern or losing pattern, on different devices.

Having summarized certain features of epulltab systems of the present disclosure, reference will now be made in detail to the description of the disclosure as illustrated in the drawings. While the disclosure will be described in connection with these drawings, there is no intent to limit it to the embodiment or embodiments disclosed herein. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

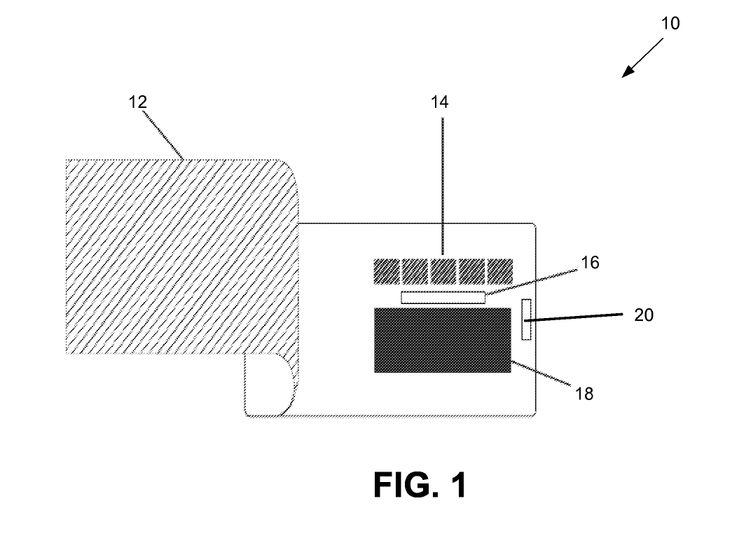

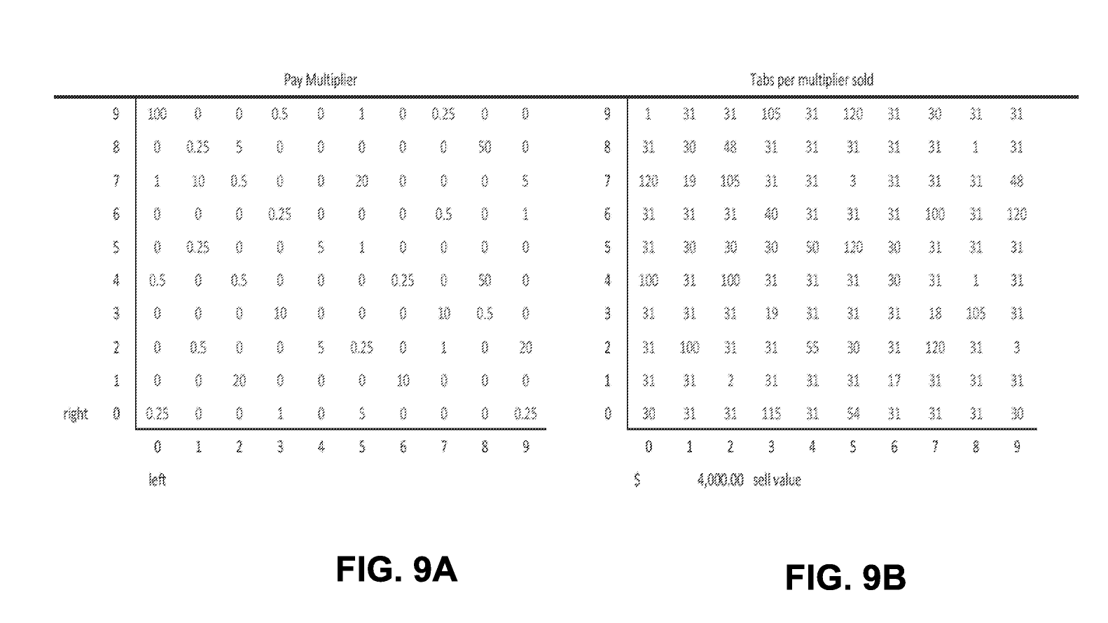

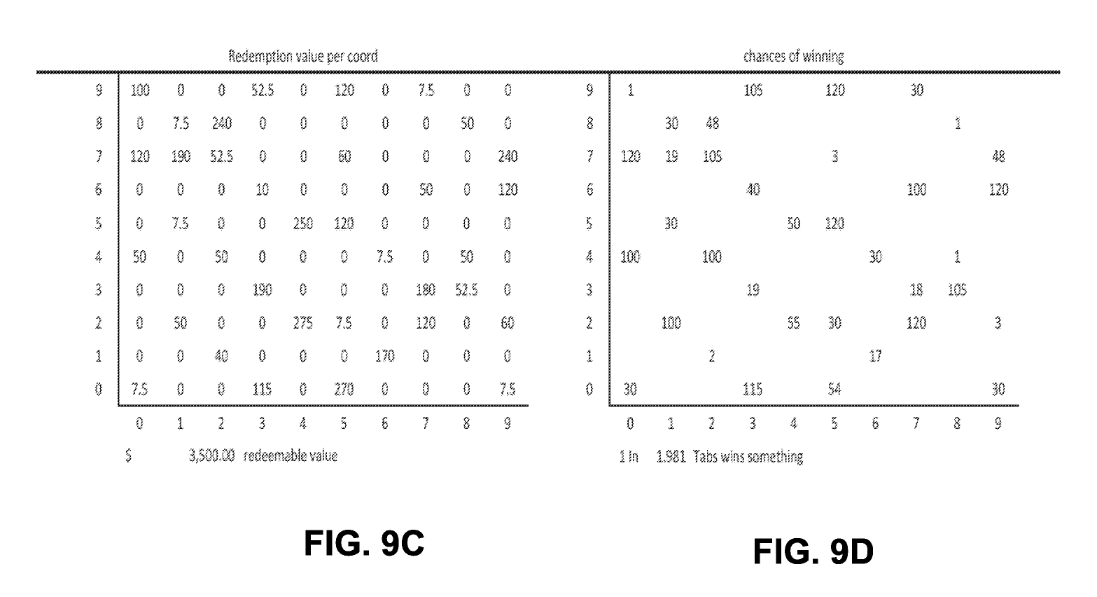

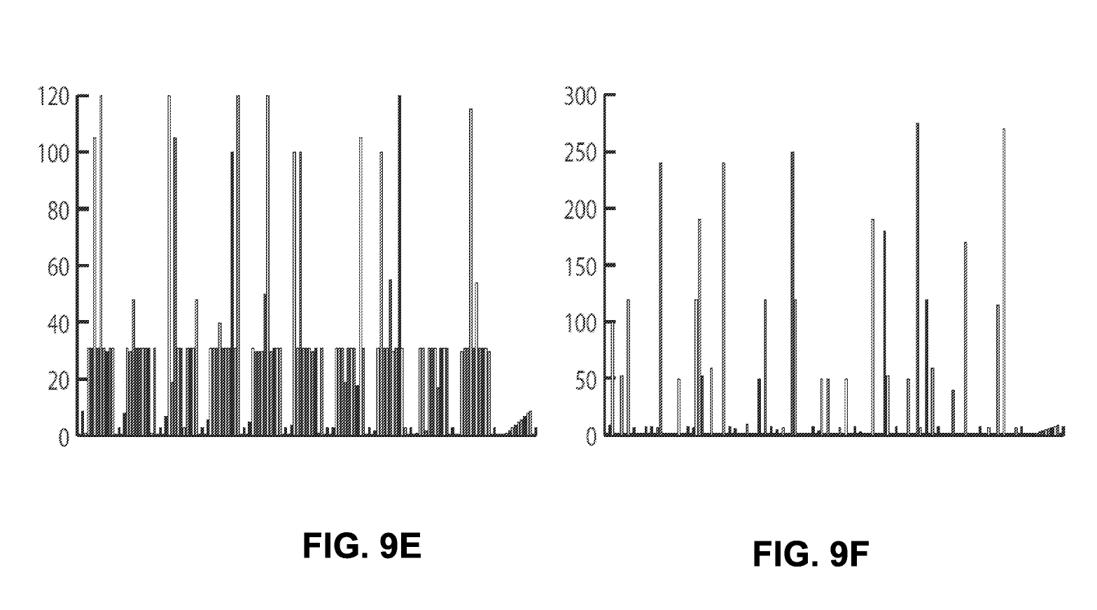

FIG. 1 is a schematic diagram that illustrates an embodiment of an example epulltab 10. It should be appreciated by one having ordinary skill in the art, in the context of the present disclosure, that variations in the design (e.g., arrangement of information) may be used in some embodiments, and hence are contemplated to be within the scope of the disclosure. The epulltab 10 comprises a paper tab with an adhesive layer 12 that is peeled back to reveal certain information that was obscured from view by the adhesive layer 12. In one embodiment, the epulltab 10 comprises a win code 14, an encrypted code 16, and a bar code 18. In some embodiments, more than a single encrypted code and corresponding bar code may be printed on or otherwise affixed to the epulltab 10. For instance, the bar code 18 may be too dense (e.g., thinner, smaller lines) for less sophisticated scanning equipment to scan reliably. In such embodiments, an additional, less dense bar code may be used that embodies the same or similar information as the other bar code 18. The win code 14 provides plural (e.g., five (5)) symbols that a consumer compares to a pay table located on the back of the epulltab 10 to determine if the arrangement of symbols matches one of the winning (reimbursable or rewarded) patterns, and if so, what the pay out amount is for each winning pattern. The encrypted code 16 is an encrypted, multi-digit number (e.g., thirteen (13) integer numbers) that corresponds to certain information about the epulltab 10 and its redeemable value that may be revealed upon decryption. For instance, the encrypted code 16, when decrypted, provides the batch number, tab number, and a pay out value. In general, the epulltabs 10 are generated in groups of tabs, or batches, where the number of batches (e.g., also known as the serial or series number) may be represented by a number ranging from and including 0001 to 9999. The tab number may represent a value that is constrained by legal requirements. For instance, since each batch of epulltabs 10 may be legally limited to no more than four-thousand (4000) results (e.g., plays), the tab number may take on a value ranging between and including 0001-4000. As is described further below (e.g., in association with FIGS. 9A-9F), the pay out value (or simply, pay value) is a grid locator (e.g., x, y coordinates) in coordinate space that is assigned a multiplier of the original purchase price. The bar code 18, which in one embodiment is located adjacent the encrypted code 16, may be embodied in a bar code format suitable to duplicate the encrypted code and its corresponding information, and in one embodiment, is configured as a one-dimensional bar code or in some embodiments, as a two-dimensional code such as a QR code, among other formats well-known to those having ordinary skill in the art. As described below, using a chain of algorithmic operations, these values for batch and tab numbers and pay value are manipulated by an embodiment of an epulltab system 10 into an indecipherable string that obscures the meaning of each value. As an example, if tab number 1234 from batch number 0987, which is sold for $1.00, has a win code value of $5.00, then a pay grid has a coordinate value of {5,6}, and the encrypted code is 7212344098341. The encrypted code is simple, numeric, and easily portable across different mediums. The epulltab 10 may include additional information, such as a batch number 20 that is shown in plain text format and un-obscured by the adhesive layer 12, as well as the pay tables on the back side (not shown) of the epulltab 10 and any legal verbiage, as is conventionally known.

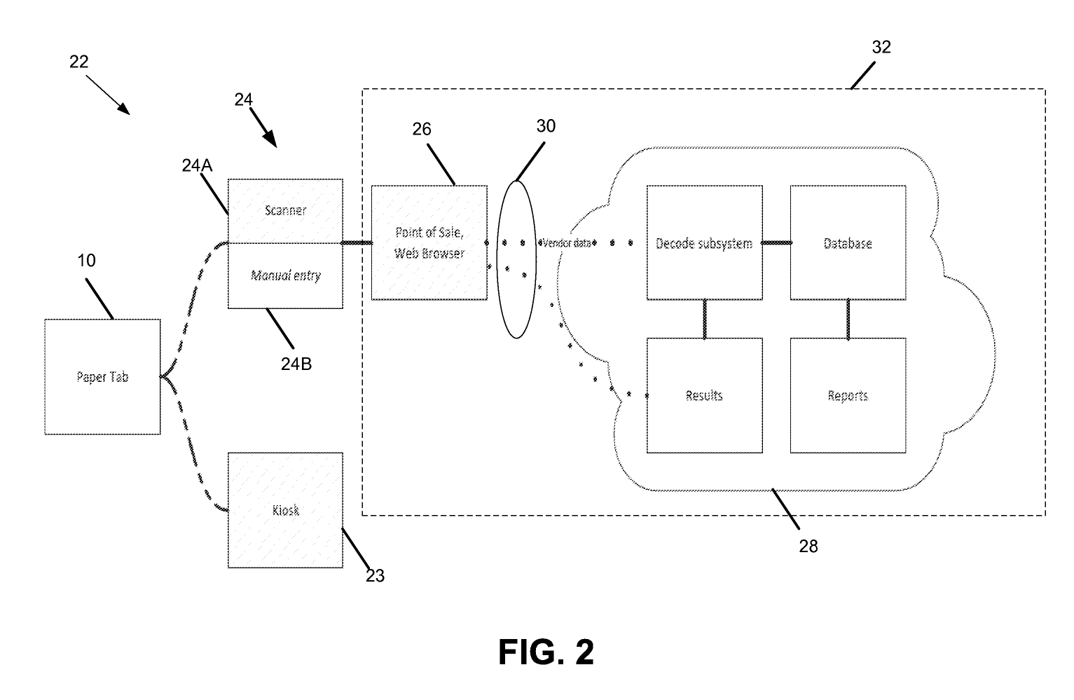

Having described one component of an epulltab system, attention is directed to FIG. 2, which illustrates an embodiment of an example epulltab system 22. It should be appreciated by one having ordinary skill in the art, in the context of the present disclosure, that some embodiments of epulltab systems may comprise fewer components or additional components. The epulltab system 22 comprises the epulltab 10, one or more kiosks 23, tab interface(s) 24, a point of sale (POS) web browser 26 (e.g., hosted by a computing device), and a remote computing system 28 coupled to the web browser 26 over a network 30. The network 30 may comprise a single network, or a plurality of networks, including a cellular, local area network, wide area network (e.g., the Internet), etc. In one embodiment, the web browser 26 (and its host device) and the computing system 28 collectively comprise a portal system 32, wherein the computing system 28 hosts a web service (e.g., providing a virtualized server environment) and the web browser 26 accesses the web service to validate the epulltab 10. The kiosks 23, the tab interfaces 24, and the web browser 26 may be located in a vendor facility, such as a convenience store, gas station, among other stores. The tab interfaces 24 comprise, in one embodiment, a bar code scanner 24A and a manual interface 24B, such as a keyboard, keypad, or touch-type or motion-sense interface of a computing device. Note that the kiosks 23 may have tab interfaces that perform similar functionality to the tab interfaces 24. A consumer may scan his or her epulltab 10 (e.g., scan the bar code 18, FIG. 1), or the consumer may pass possession of his or her epulltab 10 to a vendor (e.g., employee of the vendor), whom in turn scans the bar code 18 of the epulltab 10 using the bar code scanner 24A. In some implementations, the consumer (or vendor on the consumer's behalf) may enter the encrypted code 16 (FIG. 1) of the epulltab 10 via the manual interface 24B. The web browser 26 may be hosted by a work station, laptop, tablet, personal computer, or other device with Internet connectivity. The device hosting the web browser 26 is coupled to the tab interface 24, such as via a wired or wireless medium. In some embodiments, the functionality of the tab interface 24 and the device hosting the web browser 26 may be combined into a single device (e.g., such as a smartphone or tablet with integrated camera and keyboard). The remote computing system 28 may include one or more computing devices that individually, or collectively, comprise decoding functionality (including decrypting functionality), a data structure (e.g., database), report generation functionality, and results functionality (e.g., validation, recording, etc.). In some embodiments, the computing system 28 may comprise batch generation and encryption functionality, though in some embodiments, the batch generation and/or encryption may be generated elsewhere and accessed by or transferred to the computing system 28.

In one example operation and with continued reference to FIG. 2, data is received at the portal system 32. For instance, a consumer (or vendor) scans the bar code 18 (FIG. 1) or manually enters the encrypted code 16 (FIG. 1) of the epulltab 10 at the tab interface 24, and the tab interface 24 communicates the scanned or manually entered information to the portal system 32. The portal system 32 (e.g., the remote computing system 28) decrypts the encrypted code 16 and parses the data for comparison with a previously stored value (e.g., stored based on the epulltab generation, encryption, and/or recording of the generation/encryption) for the corresponding batch and/or tag number. That is, and digressing briefly, before each epulltab 10 reaches its vendor destination, it is created elsewhere (e.g., at the remote computing system 28 or elsewhere and information corresponding to the generation and/or encryption accessed by or transferred to the remote computing system 28). The batches of epulltabs 10 are generated, each assigned a given batch number and tab number, with a win code also generated for each. The information pertaining to each epulltab 10 is encrypted as an encrypted and bar-coded value or PIN number. The batches of epulltabs 10 are printed out and assigned (e.g., by an administrator) a respective vendor, and the vendor assignment and other information, including information corresponding to all or a portion of the encrypted code, are stored in one or more data structures of the remote computing system 28. The generation of the encrypted code and vendor assignment serves as a first activation of the corresponding epulltab 10. When the epulltabs 10 are shipped to the vendor, there is a code on the packaging that is scanned to confirm that the shipment reached its destination, as explained further below. In one embodiment, validation of each epulltab 10 presented for redemption (at the point of sale (POS)) involves receipt of the scanned or entered encrypted code, and a comparison (e.g., Boolean operation, etc.) by the portal system 32 of at least a portion (e.g., the batch number) of the decrypted information with the previously stored value (which implicates the appropriate vendor and pay value). The portal system 32 determines whether there is a match in the batch number (or in some embodiments, comparison among additional and/or alternative decrypted information, such as comparison to a stored tab number, pay value, etc.), which implicates the vendor assignment, and if there is a match, the epulltab 10 is validated (e.g., activated a second time). Once activated the epulltab 10 may be redeemed based on any winning result.

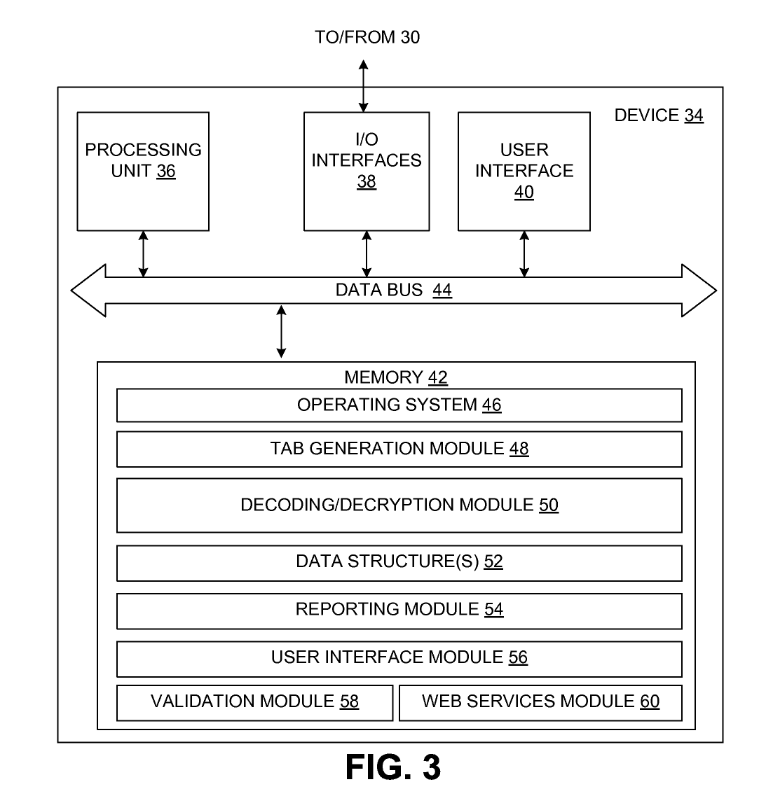

FIG. 3 is a schematic diagram that illustrates an embodiment of an example remote device 34 of the remote computing system 28 generally depicted in FIG. 2. It should be appreciated, within the context of the present disclosure, that fewer or additional components may be used in some embodiments, and that functionality described in association with the remote device 34 may be further distributed among one or more additional devices co-located with, coupled to, or separate and independent from, the remote device 34 and/or computing system 28. Referring to FIG. 3, the remote device 34 is depicted in this example as a computer system. It should be appreciated that certain well-known components of computer systems are omitted here to avoid obfuscating relevant features of the remote device 34. In one embodiment, the remote device 34 comprises one or more processing units, such as processing unit 36, input/output (I/O) interface(s) 38, user interface 40, and memory 42, all coupled to one or more data busses, such as data bus 44. The memory 42 may include any one or a combination of volatile memory elements (e.g., random-access memory RAM, such as DRAM, and SRAM, etc.) and nonvolatile memory elements (e.g., ROM, hard drive, tape, CDROM, etc.). The memory 42 may store a native operating system, one or more native applications, emulation systems, or emulated applications for any of a variety of operating systems and/or emulated hardware platforms, emulated operating systems, etc. In the embodiment depicted in FIG. 3, the memory 42 comprises an operating system 46, a tab generation module 48, a decoding/decryption module 50, one or more data structures 52, reporting module 54, user interface module 56, a validation module 58, and a web services module 60. It should be appreciated that in some embodiments, additional or fewer software and/or firmware modules (e.g., combined functionality) may be employed in the memory 42 or additional memory. In some embodiments, a separate storage device may be coupled to the data bus 44, such as a persistent memory (e.g., optical, magnetic, and/or semiconductor memory and associated drives), such as to host the data structures 52. In some embodiments, functionality of the aforementioned modules may be implemented in more than a single computing device, such as distributed across a plurality of devices that are co-located or remote from each other, with the computed results communicated over a network or communicated via an intermediate portable storage device (e.g., memory stick, optical medium, etc.).

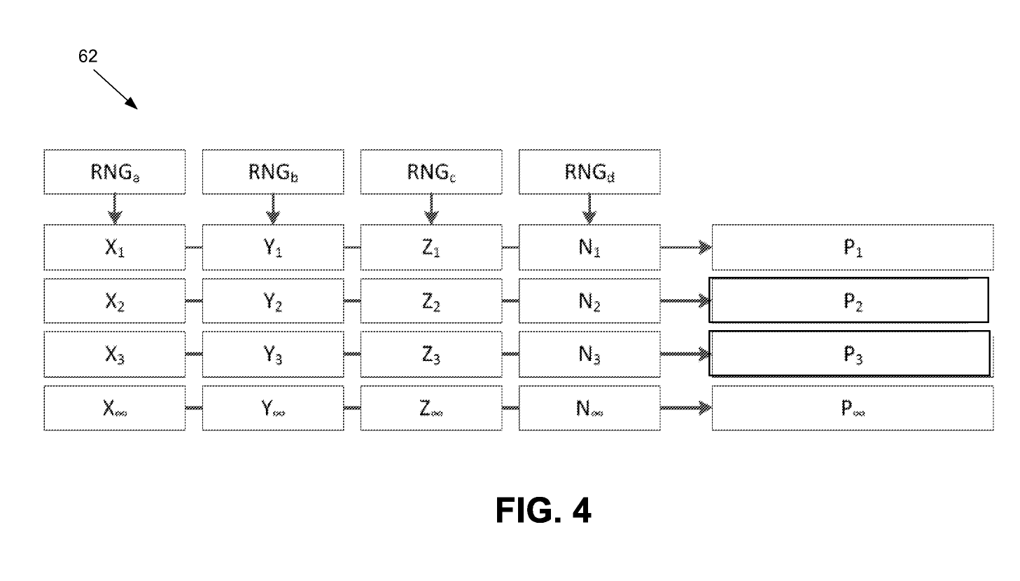

The tab generation module 48 randomizes and obfuscates the epulltabs 10 (FIG. 2). As noted above, in some embodiments, functionality of the tab generation module 48 may be distributed over plural devices, such as one device dedicated to randomization and/or printout of the tabs, and another dedicated to encryption. Pay values are determined and encoded using coordinate spaces (as explained further below), and the batch and tab numbers are encrypted along with the pay values in an encrypted format. Generation of the tabs is according to a randomization process, as detailed further below in conjunction with FIG. 4. The decoding/decryption module 50 receives (as part of a validation process) an encrypted code or bar code with the embedded encrypted code entered or scanned at the vendor facility, respectively, and decodes (the bar code) and decrypts the encrypted code. The decoding/decryption module 50 further comprises parsing functionality. The one or more data structures 52 store information pertaining to the generated epulltabs 10, such as one or more of the information corresponding to the encrypted information (e.g., batch number), and further associates each batch with a vendor (e.g., as designated or assigned by an administrator). The one or more data structures 52 may further store additional information, such as events surrounding the generation of the epulltabs 10 or use and/or activation of the epulltabs 10. For instance, the remote device 34 may store information such as active batches, depleted batches, activity by location, activity by zip code, activity by state, and/or activity by data range. In one embodiment, an administrator activates each batch number and assigns a vendor to a respective batch or batches. In some embodiments, assignment may be done as an automated process (e.g., without administrator intervention). Each time an epulltab 10 is scanned (or its encryption code manually entered), the portal system 32 makes a record to the data structure(s) 52, including such information as who scanned or entered the information, when, where, and for how much. The reporting module 54 enables reporting of the recorded information as a summary or as detailed data sets. The user interface module 56 provides a user interface for an administrator to assign vendors or prepare reports, among other administrative functions. The validation module 58 provides a comparison of at least a portion of the decrypted and parsed data extracted from the encrypted code with the data previously stored in the data structures 52 during or proximal in time to the epulltab creation process, such as data pertaining to the recorded batch, and/or in some embodiments, the tab number and/or pay value for the scanned or manually entered information at a vendor site. The web services module 60 provides a web interface for the device hosting the web browser 26 (FIG. 2).

Execution of the aforementioned modules 48-60 may be implemented by the processing unit 36 under the management and/or control of the operating system 46. The processing unit 36 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the remote device 34.

The I/O interfaces 38 provide one or more interfaces to the network 30 (FIG. 2) and other networks. In other words, the I/O interfaces 38 may comprise any number of interfaces for the input and output of signals (e.g., analog or digital data) for conveyance over the network 30, including according to one of a plurality of protocols, such as TCP/IP, FTP, among others well-known to those having ordinary skill in the art.

The user interface 40 may comprise a graphics user interface presented on a display screen, a keyboard or keypad, a mouse, touch-type display, microphone, among other user interface devices well-known to those having ordinary skill in the art.

When certain embodiments of the remote device 34 are implemented at least in part as software (including firmware, where modules generally refer to the software and/or firmware), as depicted in FIG. 3, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the remote device 34 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Having described certain features of the various components involved in some embodiments of an epulltab system 22 (FIG. 2), the following description focuses on the tab generation and encryption processes. Digressing briefly, gaming and entertainment systems data is normally transferred over insecure lines of transmission, and the information is easily decoded and exploited. Traditionally, such data transfers occur over TCP/IP protocols commonly used over Internet and network connections, with the information sent either as a static file transfer or via serialized packets of information. However, such unsecure communications are easily listened in upon and exploited for their inherent value (as supported by vendors in disparate locations). That is, the information is kept as readable data (clear or plain text), as to be clear enough to be simply ingested by the receiving system. In contrast, certain embodiments of an epulltab system 22 organize large sets of data and then render the information to be obscured or unreadable during transmission. As noted above, the epulltab system 22 also comprises functionality to ensure the information is verifiable as true and correct by the receiver of said data. For example, if a gaming commission or private entity desires to transmit a mathematics pay model used for casino based operations from one facility to another, a series of packets can be transmitted securely without the need to be concerned with wire-bound security techniques. Any method can be used to transmit or relay the data, whether verbal, written, or digital.

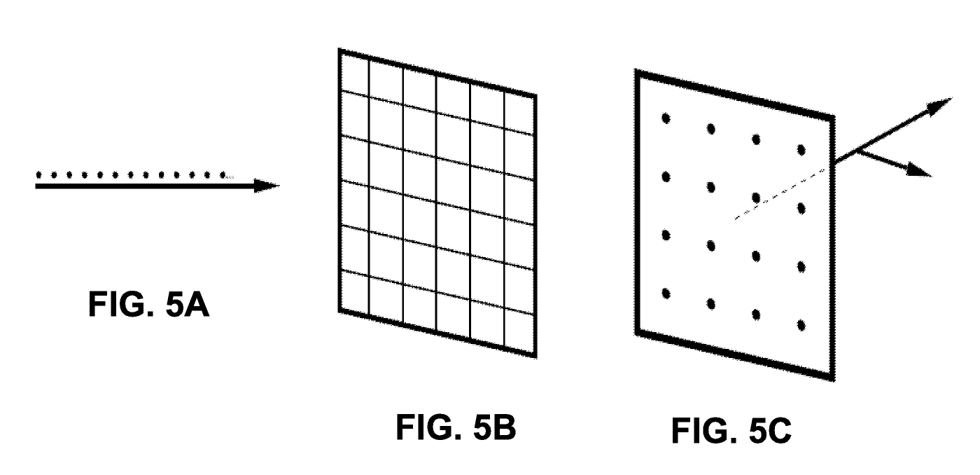

With the aforementioned general background in context, and having described some example functionality of the remote device 34 (FIG. 3) of the remote computing system 28 (FIG. 2), attention is now directed to FIGS. 4-9F, which illustrate certain functionality involving the tab generation module 48. In particular, FIGS. 4-9F illustrates epulltab payout value definition, randomization of the epulltabs, and then encryption of the epulltabs as part of the overall epulltab batch construction. As noted above, the tab generation module 48 may be hosted by the remote device 34, or other (e.g., co-located or remote) devices in some embodiments. In one embodiment, and referring in particular to FIG. 4, shown are plural random number generators (RNGs) 62 of, or associated with, the tab generation module 48. The random number generators 62 may be embodied as software, hardware, or a combination of software and hardware. Note that reference to random is understood to refer to pseudo-random operations. The generation of epulltabs 10 into batches involves a randomization process that previously was manually performed. In one example operation, an administrator opens up a charting tool that enables the selection of multipliers and their respective quantities for a given batch of epulltabs 10. In conjunction with creating a randomized coordinate space, a user (e.g., administrator) may define the frequency of certain key values to appear in the coordinate space and then recalculate the coordinate series to achieve a frequency that matches the desired output, as described above in conjunction with FIGS. 9A-9D. With each desired field of data, an additional dimension is defined in a charting system. A single field of information may be charted as a line (FIG. 5A) and two fields of information may be charted on a Cartesian plane (FIG. 5B). Additional fields may be supported to manage Nth dimensional data references, where the more data fields that are defined utilize additional points of definition to create a non-Cartesian charting space (FIG. 5C). For instance, and referring to FIG. 9A (where FIGS. 5A-5C reveal the level of extrapolation that can be achieved with FIGS. 9A-9B), the administrator may adjust the pay multipliers in a matrix for a given batch, and as shown in FIG. 9B, the quantity of epulltabs 10 at the respective multipliers. In FIG. 9A, the 0.5 multiplier value at {3, 9} provides a payout of $0.50 on a dollar purchase of an epulltab 10, and according to FIG. 9B, the quantity at the coordinate space is 105 in a batch of 4,000. The administrator may adjust these values as he or she sees fit, such as to skew the outcomes using more multipliers of 1 (and less of zero, resulting in more big winners, for instance). Referring to FIG. 9C, the values in FIG. 9A multiplied by the values in FIG. 9B provides the result found in FIG. 9C, which is the redemption value (e.g., 0.5×105=52.5 for {3, 9}). FIG. 9D provides the payout ratio, which in this example, is 1.981. These manual definitions, wherein the administrator balances out the distribution across the coordinate space, form the basis for the underlying payout values for the batch of epulltabs 10, and is a process generally referred to herein as generating a math model. With the math model determined, a next step is to perform randomization of the payout values in a given batch.

In the past, pulltab randomization was purely a manual process, wherein the pulltabs were printed out, each tab separated, and then shuffled like cards. In certain embodiments of an epulltab system 22 (FIG. 2), the randomization is automated. As one example to help visualize the process, assume the creation of a 2D spreadsheet (e.g., a grid of multiplier entries), where there are forty (40) entries of a 0.25 multiplier, sixty (60) entries of a 0.5 multiplier, and so on. Numbers (referred to herein as side-car numbers) are randomly (pseudo-randomly) generated for each entry (which corresponds to a respective tab), and then the list of entries is sorted in an ordered sequence according to the random numbers (e.g., from smallest to highest) while retaining the association with the respective coordinate values. When sorted linearly, the result is a random output of pay values (and a discarding of the side cars). In general, each value of payout is assigned a random side-car number, where the side-car number changes length based on the requested batch size. The larger the batch, the larger the side-car to maintain the probability of uniqueness. The payout values are sorted by the side-car values in linear fashion, and a unique tab number is assigned to a payout value at that point (e.g., after the randomization). The tab number and batch number are abutted in a manipulation process to generate the encrypted number.

The random number generators 62 generate sequences of whole, single digit random numbers (e.g., side-car numbers), enabling complex data references to be transformed into coordinate space (e.g., Cartesian and non-Cartesian plotting spaces) with reasonable uncertainty and obfuscation. As a process, a couple of factors are considered before the engine (e.g., the tab generation module 48) is set in motion. Firstly, the amount of unique data points are defined. The amount can be most any value, with the upper limits limited by processing time and memory space. Secondly, the amount of unique types of values are defined in orders of magnitude varying from 1¹ to 10¹⁰. For instance, if a large batch of values (e.g., greater than 100,000) needs to be described, a set of unique values are constructed with a low likelihood of containing duplicates. To minimize the chance of duplication, numerical strings that are greater than the digit size of the batch may be constructed. A batch of 100,000 may only need a 6-digit unique identifier, but when using pseudo-random generation for only six (6) digits, there is a margin of duplication. By using numbers that are orders of magnitude larger, the risk of duplication is significantly reduced. Once those two factors are decided, a simple RNG is used to generate whole digit sequences of the data point length. The more unique fields of data desired defines how many iterations of this string is generated. The more strings that are generated, the more expansive the random number generator (RNG) string of output values. That is, to create a reasonably random output of values, multiple RNGs 62 are used in conjunction with each other to create a lower likelihood of duplicate values and increased randomness. The RNGs 62 in FIG. 4 demonstrate how the side-car numbers referenced above are generated. For instance, RNGa outputs X1. Another instance of the RNG (e.g., RNGb) outputs another value, Y1, and as many RNG instances (e.g., RNGc, RNGd, etc.) may be used to reach the desired character size. In the above example of a 100,000 unit batch, three (3) orders of magnitude may be used to reach a safe character density (e.g., 100,000,000 or nine (9) digits). In that case, each RNG pseudo-randomly outputs 3-digit numbers, and by abutting each number, X1X2X3, Y1Y2Y3, Z1Z2Z3, a unique 9-digit string is assembled (e.g., P3), reducing the chance of duplication. In general, the output of these RNGs 62 are sorted in list fashion in a Cartesian plotting space, generating as long of a string as units of information to be encoded. For instance, if there are 10,000 unique pieces of data to be transmitted, then a 10,000 unit string for X, Y, Z, N are outputted (X₁ through X_{10,000}, etc.). Each data field's RNG outputs are mapped onto the aforementioned Cartesian plane in a columned format and abutted, yielding P. P is a new, randomized output string with sufficient density to support sorting for larger and larger data sets with minimal (e.g., >0.0001%) chance of duplication. One benefit to the aforementioned randomization process is that very simple RNGs 62 may be used with very low computing power, since smaller, simpler RNGs are used to create longer strings (longer side-cars), as opposed to a more advanced, computationally hungry algorithm. Note that, although a specific algorithm has been described for randomization, in some embodiments, other mechanisms to randomize the payout values of a given batch may be used, and hence are contemplated to be within the scope of the disclosure.

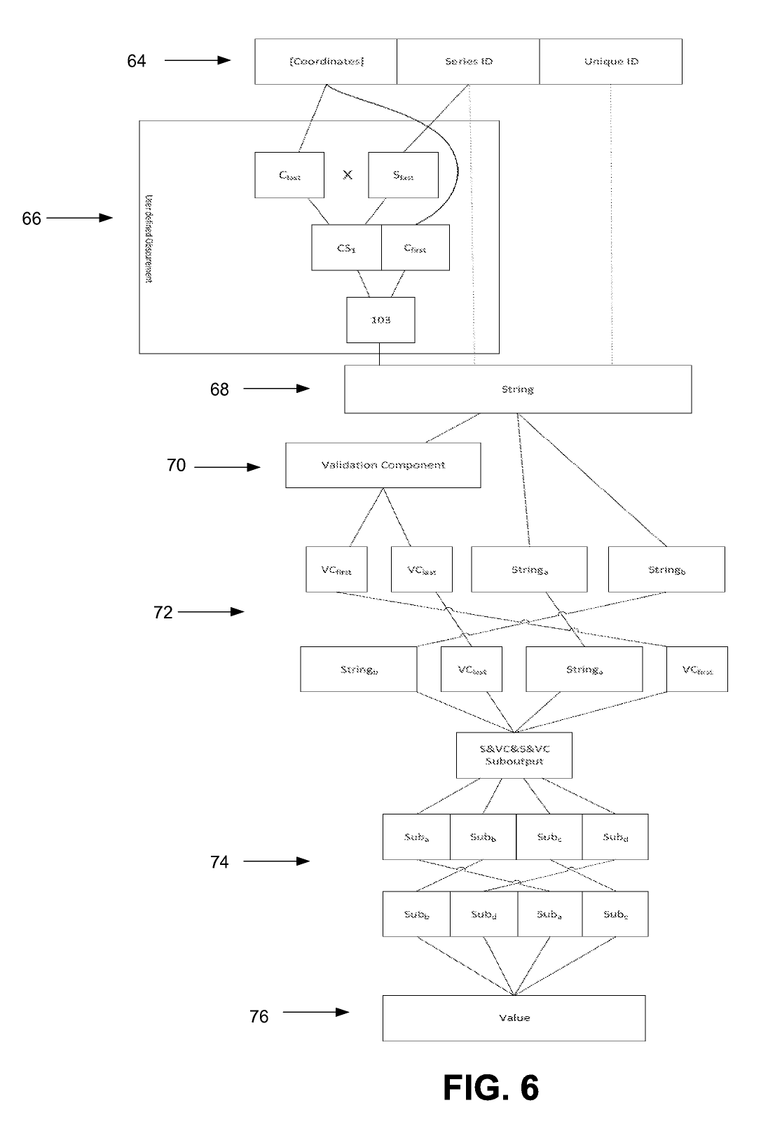

As noted above, once the mapping is complete, a user inputs a key generating event (to commence RNG operations) by specifying a series of simple operands in a series of data manipulations to define a process and make unique. Upon assignment of the unique generating event a batch of strings may be generated in a similar, yet pseudo random order. For a single embodiment, the series are abutted and conjoined into columned structures used for mapping the RNG outputs as strings of variable length to be used as coordinate points. Having described one embodiment of epulltab batch randomization and the underlying manual definition of the math models, attention is now directed to FIG. 6, which depicts an embodiment of an encryption mechanism, such as implemented in one embodiment by the tab generation module 48 (FIG. 3) in conjunction with the epulltab generation process. To perform the final assembly and output of the data, the charting coordinates to be transmitted are assembled, along with two additional identifiers (64). These identifiers, a unique ID (e.g., tab number) and series ID (e.g., batch number), are used to locate the information superset for future sorting and application. These two additional fields may be as simple as the date of creation and the number of the batch created that day (e.g., Oct. 2, 2010, batch #4, for example). With this set of identifiers and information created, a system is enabled to utilize a simple mathematical system in order to obfuscate the actual values of the data to be transmitted (66). Once the data is assembled and obfuscated, the string is complete (68). The combinatory value of the string is found in order to create the validation component (70). The string is then manipulated in a standardized reorganizational process in two iterations, where the string is broken apart into non-uniform subsections and reordered twice (72). Once these ordering are complete, the remaining segments of the disambiguated string are then re-adjoined (74) to create the final value (76). The value is the final packet of information ready to be transmitted by any mechanism desired.

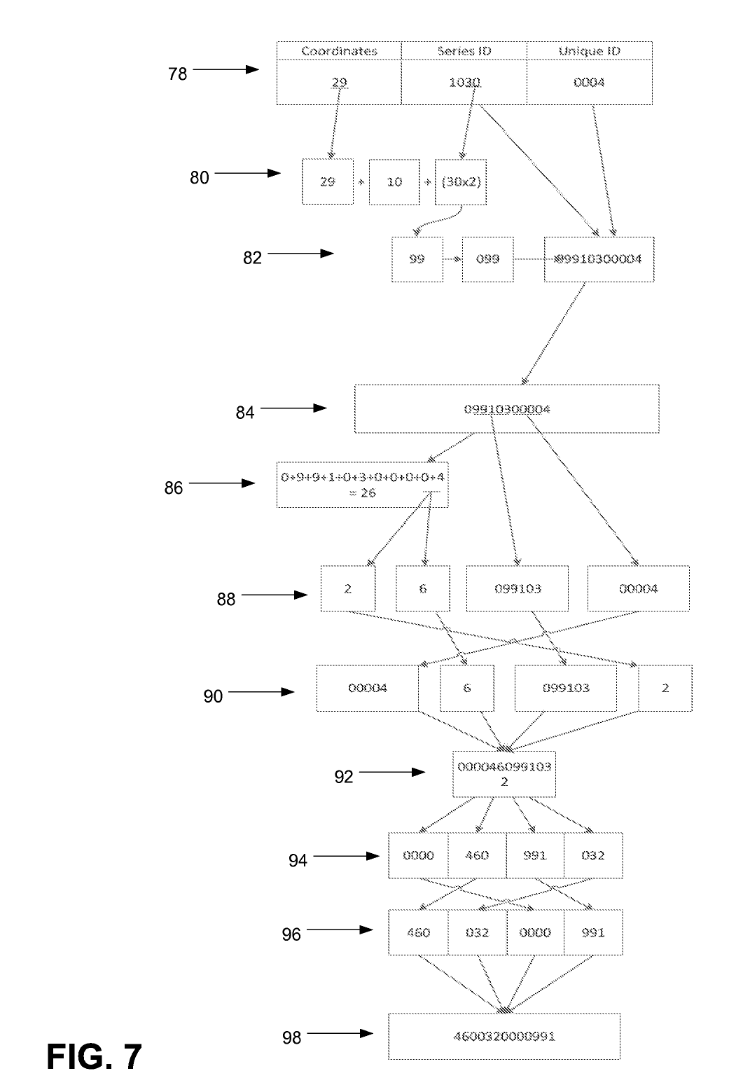

FIG. 7 is a schematic diagram that illustrates an embodiment of an example encryption mechanism used by an embodiment of the remote device 34 of FIG. 3. It should be appreciated that the example encryption mechanism depicted in FIG. 7 is merely illustrative of one example, and that other values and/or rearrangement in steps may be performed in some embodiments, and that encryption may be performed on other devices. At (78), a base value of the grid number or coordinates (e.g., 29), series ID (e.g., 1030), and unique ID (e.g., 0004) are shown. Then, a mathematical operation comprising the coordinates+10+(last two digits of the series ID#×2) is performed (80), with the result formatted as three (3) digits and abutted with the series ID number and unique ID number (82). The resultant string (84) is used to find a combinatory number (e.g., the addition of each digit of the string) (86). The string and combinatory value are then assembled according to the left and right combo digits and the left six and right five digits of the string (88). The result of (88) is then reordered beginning with the right five digits of the string, the right combo digit, the left six digits of the string, followed by the left combo digit (90) to achieve a thirteen (13) digit assembled intermediate code (92). The code is segmented into four (4) segments to prepare for the bar code build (94), re-ordered as 2, 4, 1, 3 segments (96), resulting in the final pin or encrypted code (98), and in this example, 4600320000991. Note that in some embodiments, variations of this encryption process may be performed to obfuscate the data.

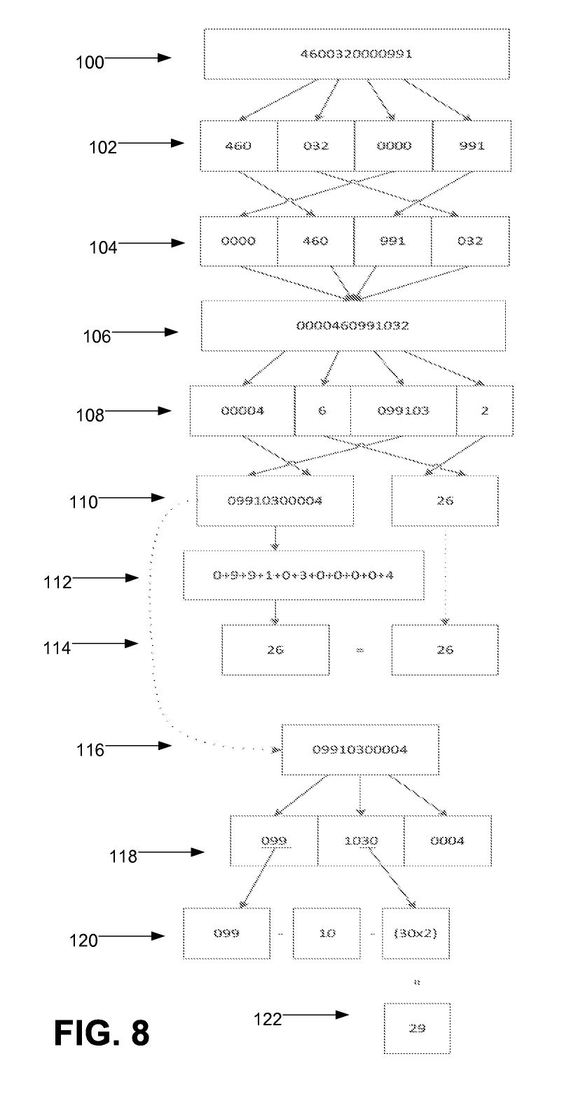

FIG. 8 is a schematic diagram that illustrates an embodiment of an example decryption mechanism used by an embodiment of the remote device 34 of FIG. 3. Beginning with the encrypted code value (100) created in FIG. 7, the value is segmented (102) and reordered (104), and the result (106) is decomposed (108) and adjoined in a different order to rebuild the string and checksum for testing (110). A combinatory value is generated on the 11-digit string portion and through a Boolean operation, if the value tests true with the checksum (114), then the decrypting process continues using the string (116) and extracting coordinate data from the string, resulting in the coordinate code, series ID number, and unique ID number being identified (118). Then, through mathematical manipulation (e.g., taking the coordinate code, subtracting 10 and further subtracting the last two (2) digits of the unique ID number times two (2)) (120), the coordinate ID number (e.g., 29) is identified (122). In some embodiments, variations of this process may be performed based on alterations to the encryption mechanism described in FIG. 7.

FIGS. 9A-9F, which have been described previously, are schematic diagrams that illustrate some example information corresponding to encrypted codes used in an embodiment of an epulltab system 22 (FIG. 2). That is, FIGS. 9A-9D provide an underlying layout for determining the coordinates of payouts for a math model used in an embodiment of an epulltab system 22. Referring to FIG. 9A, shown is an example pay multiplier on a grid of a purchase price. For instance, a coordinate space of {4,5} corresponds to an x, y or left, right coordinates, which in this example provides a value of five (5). In other words, this pay value is a 5× payout, or using an epulltab purchase value of $1.00, a payout of $5.00 (or if purchased for $5.00, a payout value of $25). FIG. 9B shows an example distribution frequency for each coordinate value, and in particular, revealing tabs per multiplier sold based on a $4000.00 aggregate sell value. Using the payout value associated with {4, 5} described above, one observes that there are fifty (50) of these payout coordinates. FIGS. 9C-9D are alternate views of the defined information of FIGS. 9A-9B. For instance, FIG. 9C shows a heat map revealing the density of pays and values (e.g., redemption value per coordinate, based on an aggregate $3500 redeemable value). FIG. 9D shows the amount of tabs that do have a redeemable value, and the chances of receiving anything in exchange. In this example, there is a 1 in 1.981 chance of winning some multiplier greater than zero (0) of the purchase price something. FIGS. 9E and 9F illustrate a distribution model for multiplier values and redemption values, respectively. As noted previously, an administrator may use and edit such information to achieve the desired result.

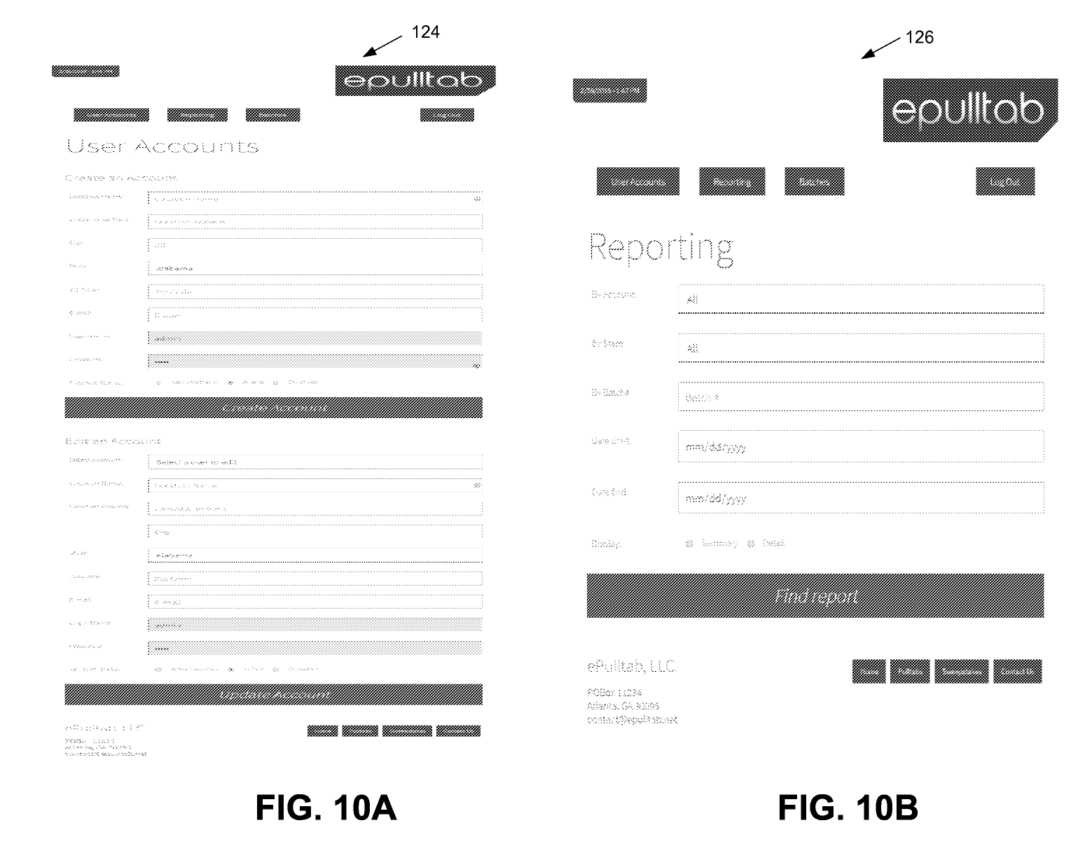

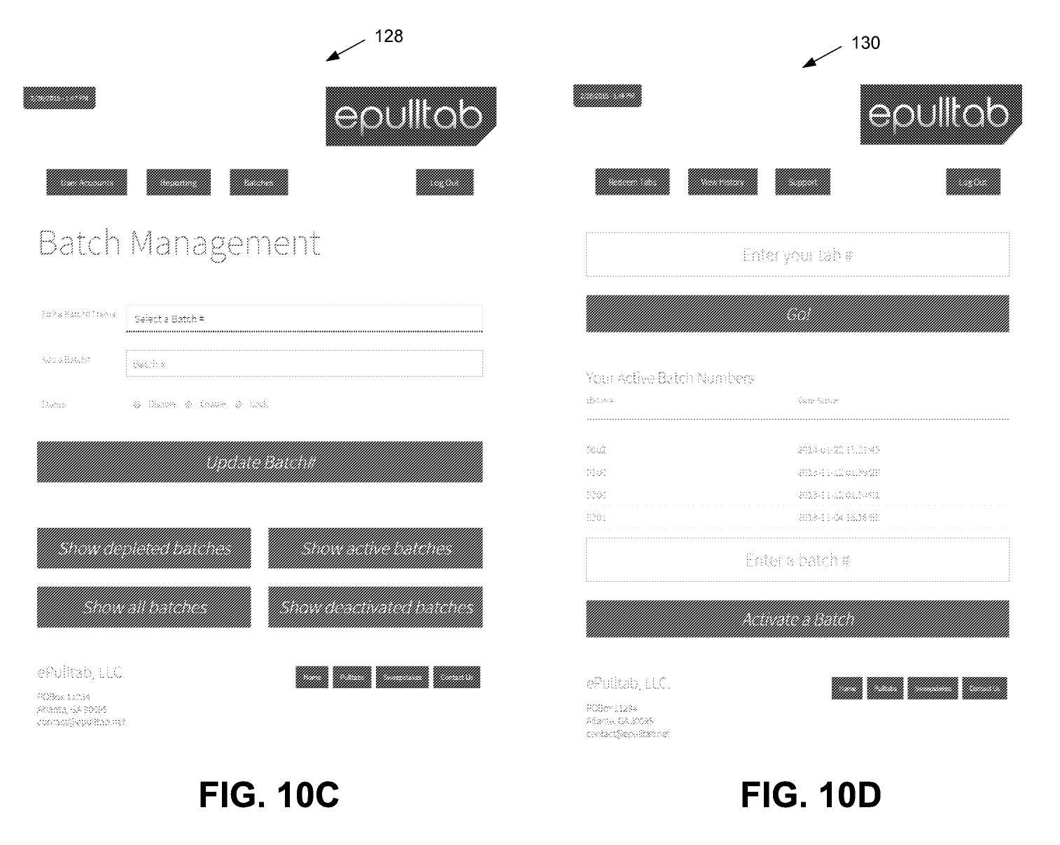

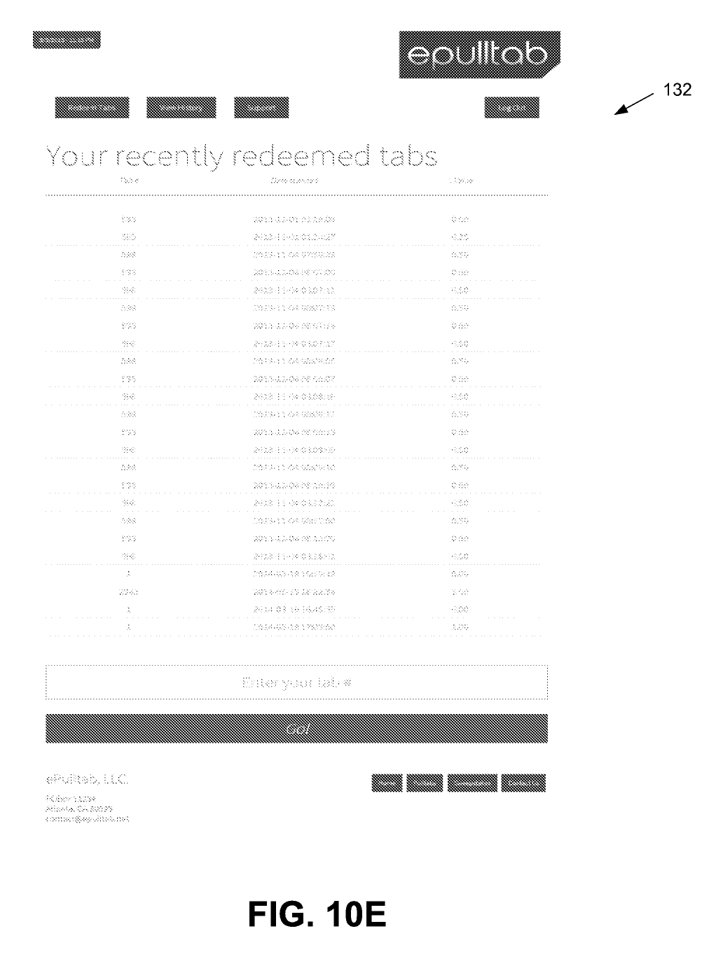

Having described certain processes associated with the tab generation module 48 (FIG. 3), attention is directed to some example user interface screens in FIGS. 10A-10E that are generated by the user interface module 56 (FIG. 3) and presented (e.g., FIGS. 10A-10D) via a display screen of the user interface 40 (FIG. 3) of the remote device 34 (FIG. 3) to provide an administrator with the ability to monitor various processes associated with batch generation and reporting and presented (FIG. 10E) to a vendor. It should be appreciated by one having ordinary skill in the art, in the context of the present disclosure, that the example user interface screens are for illustrative purposes, and that additional or fewer information may be presented in each respective screen and/or presented in additional or fewer screens. In some embodiments, these screens may be presented on a device that is different from the remote device 34, such as the device hosting the web browser 26 (FIG. 2). The format of each user interface screen is also for illustrative purposes, and other formats may be used in some embodiments and are contemplated to be within the scope of the disclosure. Referring to FIG. 10A, shown is a user interface screen 124 that may be presented by the user interface module 56 at the remote device 34. The user interface screen 124 provides an administrator with an electronic tool for account management. For instance, the user interface screen 124 may be used to establish a vendor as an account, with fields for entering such information as name and location of the vendor, contact information, and login credentials.

FIG. 10B provides an illustration of another user interface screen 126 that provides an electronic tool for an administrator to generate usage reports, in cooperation with the reporting module 54 (FIG. 3). The user interface screen 126 enables an administrator to search by account, region, and/or batch number, constrained by a defined period. The user interface screen 126 enables the administrator to choose a summary or detailed data set as the visual manifestation of the desired report.

FIG. 10C presents a user interface screen 128 that provides an electronic tool that an administrator may use to determine the status of certain batch functions. For instance, through this user interface screen 128, in cooperation at least in part with the tab generation module 48 (FIG. 3), the administrator may update batch numbers, show depleted batches, active batches, deactivated batches, and/or all batches. The user interface screen 128 also enables the administrator to disable, enable, lock, or unlock an identified batch. For instance, these functions enable an administrator to disable a batch from ever being validated, or to simply lock and unlock a given batch on a temporary basis, serving (like the randomization and encryption processes) as an anti-fraud measure.

FIG. 10D illustrates a user interface screen 130 that enables an administrator to activate a batch and tabs from that batch.

FIG. 10E illustrates a user interface screen 132 that enables a vendor to view a history of redeemed tabs, such as for auditing purposes. For instance, the vendor may view when particular tabs were scanned.

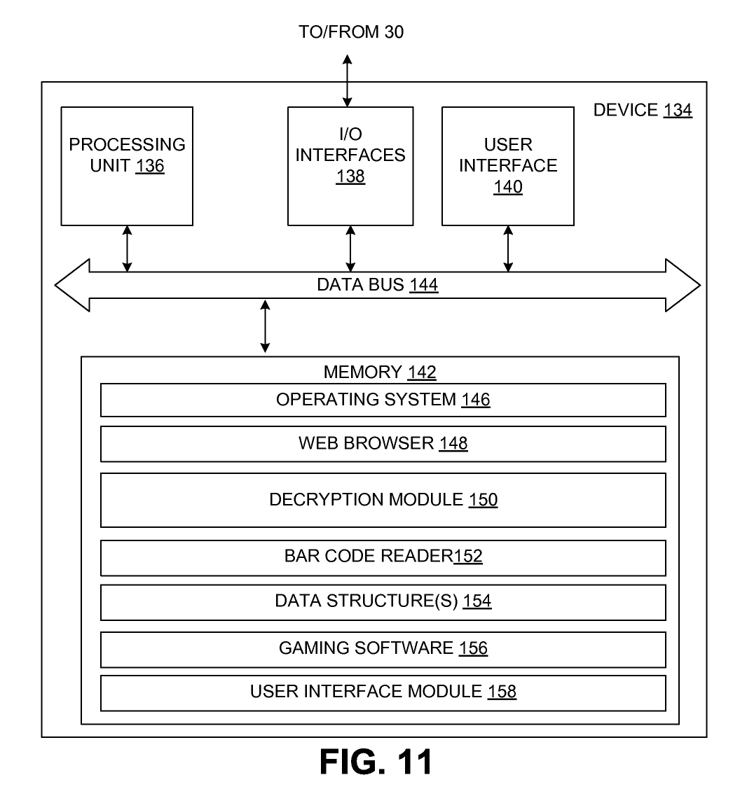

FIG. 11 is a schematic diagram that illustrates an embodiment of a device 134 that may be used at a vendor facility or elsewhere to redeem an epulltab 10 (FIG. 1). For instance, the device 134 may be used as the host of the POS web browser 26 (FIG. 2) or, with the addition of a gaming application and the omission (or optional use) of a web browser 26, the kiosks 23. The description that follows focuses on the use of the device 134 as the host for the web browser 26, where applicability to kiosks 23 noted where further explanation is warranted. The device 134 is depicted as a computer system, though it should be appreciated, within the context of the present disclosure, that the device 134 may be embodied as a smart phone, tablet, laptop, among other communications devices in some embodiments. It should be appreciated that certain well-known components of computer systems are omitted here to avoid obfuscating relevant features of the device 134. In one embodiment, the device 134 comprises one or more processing units, such as processing unit 136, input/output (I/O) interface(s) 138, user interface 140, and memory 142, all coupled to one or more data busses, such as data bus 144. The memory 142 may include any one or a combination of volatile memory elements (e.g., random-access memory RAM, such as DRAM, and SRAM, etc.) and nonvolatile memory elements (e.g., ROM, hard drive, tape, CDROM, etc.). The memory 142 may store a native operating system, one or more native applications, emulation systems, or emulated applications for any of a variety of operating systems and/or emulated hardware platforms, emulated operating systems, etc. In the embodiment depicted in FIG. 11, the memory 142 comprises an operating system 146, a web browser 148 (which may be suitable for use as the web browser 26 in FIG. 2), and optionally, a decryption module 150, bar code reader 152, one or more data structures 154, gaming software 156, and user interface module 158. In some embodiments, one or more of the software modules in memory 142 may be omitted depending on the application. For instance, for applications where the device 134 serves as a POS web browser host dedicated to validation of epulltabs 10 (FIG. 1), the decryption module 150 and/or gaming software 156 may be omitted (e.g., with the remote device 34 providing the decryption functionality and cooperating with the web browser 148 to present information about the epulltab information), and the reader functionality may be embodied in a peripheral bar code scanner 24A (FIG. 2) that is coupled to the device 134 via the I/O interfaces 138. In applications where the device 134 serves as a kiosk 23, the web browser 148 may be omitted, though in some embodiments, may be incorporated in the kiosk 23. Note that in some embodiments, some mobile devices may be equipped with gaming software and Internet connectivity that mimic kiosk applications and web browser applications. It should be appreciated that in some embodiments, additional or fewer software and/or firmware modules (e.g., combined functionality) may be employed in the memory 142 or additional memory. In some embodiments, a separate storage device may be coupled to the data bus 144, such as a persistent memory (e.g., optical, magnetic, and/or semiconductor memory and associated drives.

The web browser 148 (or equivalently, web browser 26, FIG. 2) enables interaction with the remote computing system 28 (FIG. 2) and presentation on the device 134 of a web interface for a web service hosted by the remote computing system 28. In one embodiment, the web interface provides a vendor with an interface to the web service, enabling validation and redemption of epulltabs 10 (FIG. 1). The decryption module 150 may be used to locally decrypt the encrypted code entered via the user interface 140, providing an indication of a pay out value or credits available to a customer, such as when used in a kiosk application or app-running device. The bar code reader 152 is used in conjunction with a sensor to read the one dimensional or two dimensional bar code on the epulltab 10 to enable extraction of the encrypted code. In some embodiments, functionality of the bar code reader 152 may be embodied as embedded software in a peripheral device, such as a bar code scanner, or in some embodiments where the device 134 is a smart phone or other portable device, the reader functionality may be used in conjunction with an integrated sensor (e.g., camera). The data structures 154 may be used to provide a history of validations for epulltabs 10 used in the vendor facility, and/or to track redemptions or scans/entries locally. The user interface module 158 provides for user entry of the encrypted code. In one embodiment, the user interface module 158 may require login credentials, such as when used by the vendor. In some embodiments, functionality of the user interface module 158 may be incorporated in other software, such as the gaming software 156.

The gaming software 156, and in particular for kiosk or other app-running device applications, may provide for simulated casino-style gambling games, such as poker, or a slot machine that simulates nudge mechanics via a touch screen interface. In one embodiment, the only way to play these games is by purchasing an epulltab 10 (FIG. 1) and entering the encrypted code (or scanned code) into the device 134, regardless of whether there epulltab 10 is a winner or loser. For instance, and focusing on the kiosk applications, each vendor location that participates in the epulltab system 22 (FIG. 2) also has one or more specialized kiosks 23 (FIG. 2) openly available to its customers. When a vendor chooses to place the epulltab system 22 at their retail location, they may have the kiosks 23 installed. Every 4,000 unit batch of epulltabs 10 shipped contains on its packaging a unique, proprietary code that is intended to be scanned to confirm the shipment reached the vendor. Note that kiosks 23, in one embodiment, are configured such that any epulltab 10, regardless of the source, enables simulation of game play. For instance, even if a customer never checks a login tab with a vendor (and even if the epulltab 10 is checked and does not pay anything), the epulltab 10 still works in the kiosk 23 to activate a game. In one embodiment, the game does not report back to a central system or a POS device. In some embodiments, a code is available for a vendor to use to reset a device to its default configuration. Note that the confirmation of the code on the shipping packaging is confirmed according to any one of a number of validation mechanisms. Each batch is activated in the system made available to the vendor, and when the vendor scans the code from the packaging, such an event is a signal to the system that the vendor has received the batch. As one example mechanism for confirmation, in one embodiment, the code is constructed using a unique batch number, squaring it, formatting the value as an eight (8) digit number, adjoining the batch number at the end, and prefixed the construct with the number 9 as a signifier of the command. For example, assume a code is used to activate batch number 2662. The batch number is 2662, it is squared to form 7086244, formatted to an eight (8) digit number, resulting in Ser. No. 07/086,244. A batch tail is added (e.g., 0070862442662), and a nine (9) command for QR is added, resulting in 90070862442662, which is used to activate or deactive all epulltabs 10 printed from batch number 2662. At the vendor facility, confirmation is achieved using substantially the reverse process, where the scanned code has the nine (9) dropped to provide the number 070862442662, the batch tail is separated (e.g., to 007086244-2662), the last result divided by the batch number (e.g., 7086244/2662), and a comparison made to the result (e.g., 2662=2662).

When a customer purchases an epulltab 10 (FIG. 1), the customer may open the tab and decode the contained symbology using the legend contained on the back (the classic method). The customer may also choose to scan the tab into the kiosk 23 to activate one of the aforementioned games. Each epulltab 10 allows a customer to play, for instance, one hundred (100) credits of notional value on the kiosks' embedded game simulations. The credits are entirely synthetic units of value, as there is no cash value assigned to the credits and they cannot be redeemed. A player has the option from an array of different games to utilize their credits on. They may use their credits on any and all of the games as they choose. Once a customer's notional credits are depleted, the customer purchases additional epulltabs 10 to continue playing or enter the encrypted codes from existing physical epulltabs 10. In some embodiments, an epulltab 10 may not be rescanned to activate additional credits (e.g., for single use only).

In some embodiments, the gaming software 156 may be used in another device, such as a mobile device or an in-home device, such as a computer, laptop, tablet, etc. The epulltab system 22 (FIG. 2) may be extended to such other devices. For instance, online and mobile presences may be exploited for such applications. The kiosk-based games may be ported to online and device based formats (phone and tablet). The epulltab system 22 enables customers to interact with the games in the same way as they had interacted at the kiosks 23 (e.g., at retail), yet with no geographical constraints. In one implementation, when a customer goes to the vendor site they can create a free account, only requiring a rudimentary amount of identifying information. At that time a certain amount of free credits will be available to the customer to activate a variety of the games on the kiosks 23 (e.g., by entering their old epulltab numbers into a website to replay slot-machine themed games). At any time the customer may enter a PIN (e.g., encrypted code) from an epulltab 10 (FIG. 1) into the system to make more credits available. Should the customer not possess any additional epulltabs 10 to unlock credits, they do have the option of purchasing credits in a small transaction. Traditional social media and game mechanics may be employed in order to increase end customer attachment, such as: a competitive leaderboard, a global chat system, a messaging system, a user profile, and an ‘awards’ system. In some embodiments, free credits may be available without the creation of a user account.

Execution of the aforementioned modules 148-158 may be implemented by the processing unit 136 under the management and/or control of the operating system 146. The processing unit 136 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the device 134.

The I/O interfaces 138 provide one or more interfaces to the network 30 (FIG. 2) and other networks (e.g., local area networks) or devices (e.g., a peripheral bar code scanner). In other words, the I/O interfaces 138 may comprise any number of interfaces for the input and output of signals (e.g., analog or digital data) for conveyance over the network 30, including according to one of a plurality of protocols, such as TCP/IP, FTP, USB, among others well-known to those having ordinary skill in the art.

The user interface 140 may comprise a graphics user interface presented on a display screen, a keyboard or keypad, a mouse, touch-type display, microphone, among other user interface devices well-known to those having ordinary skill in the art.

When certain embodiments of the device 134 are implemented at least in part as software (including firmware), as depicted in FIG. 11, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the device 134 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

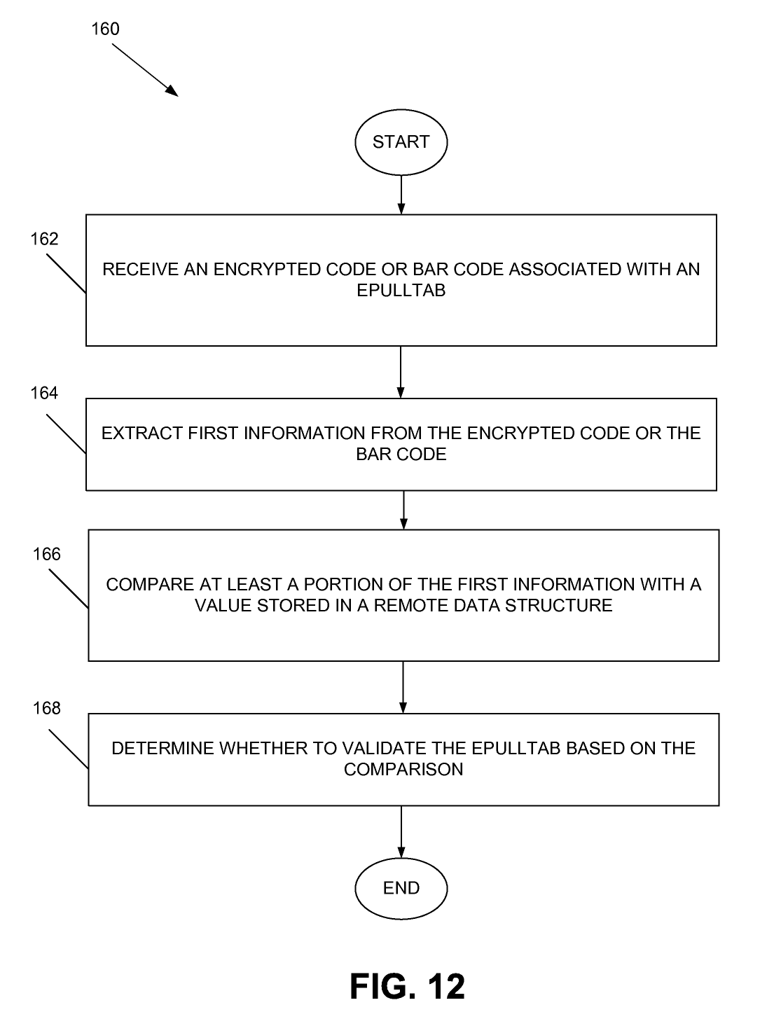

Having described certain embodiments of an epulltab system 22 (FIG. 2), it should be appreciated within the context of the present disclosure that one embodiment of an epulltab method, denoted as method 160 and illustrated in FIG. 12, comprises receiving an encrypted code or bar code associated with a epulltab (162); extracting first information from the encrypted code or the bar code (164); comparing at least a portion of the first information with a value stored in a remote data structure (166); and determining whether to validate the epulltab based on the comparison (168).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A system, comprising:
an epulltab comprising a win code, an encrypted code, and a bar code corresponding to the encrypted code; and
a portal system comprising a first device at a first facility and a remote device coupled to the first device over a network, the remote device hosting a website, the first device enabling a vendor to interact with the website, the portal system configured to:
receive the encrypted code or the bar code from the first facility;
extract first information from the encrypted code or the bar code;
compare at least a portion of the first information with a stored value; and
determine whether to validate the epulltab based on the comparison.

2. The system of claim 1, wherein the portal system is configured to extract the first information by either decoding the bar code scanned by the first device to obtain the encrypted code, and decrypting the encrypted code, or decrypting the encrypted code that is entered manually by a user at the first device.

3. The system of claim 2, wherein the portal system is configured to decrypt by:
segmenting a string of numbers into multiple segments;
reordering the multiple segments;
building a string based on the reordered segments;
performing a checksum of the string;
extracting a coordinate code, a batch number, and a tab number from the string; and
identifying a grid number based on mathematical manipulation of the string, wherein the grid number corresponds to a payout value of the win code.

4. The system of claim 1, wherein the portal system is configured to compare by comparing a batch number associated with the first information with the stored value, the stored value comprising one of a plurality of stored values uniquely assigned to a vendor associated with the first device.

5. The system of claim 1, wherein the portal system is configured to validate the epulltab responsive to matching the portion of the first information with the stored value.

6. The system of claim 1, wherein responsive to validation, the portal system enables a payout corresponding to a payout value provided in the first information.

7. The system of claim 1, further comprising a second device configured to host an electronic game, the second device configured to receive the first information based on receiving user input of the encrypted code or decoding the bar code to obtain the encrypted code, decrypting the encrypted code to obtain the first information, and providing a game result based on the first information.

8. The system of claim 1, wherein the portal system is configured to:
uniquely associate the epulltab with a vendor before the epulltab is present at the first facility;
activate for a first time the epulltab before the epulltab is present at the first facility; and
activate for a second time the epulltab based on validation by the portal system.

9. The system of claim 1, wherein the remote device of the portal system is further configured with plural random number generators and software, the remote device configured to generate the encrypted code by:
mapping outputs of the plural random number generators to a coordinate space, wherein plural coordinates correspond to respective payout values;
assigning a payout value for the epulltab to a grid number of the coordinate space;
abutting to the grid number a batch number and tab number;
mathematically manipulating the grid number a batch number and tab number to provide a combinatory number;
decomposing the combinatory number into segments;
reordering the segments to determine a final number; and
storing the final number as the stored value in a data structure.

10. The system of claim 1, wherein the portal system is further configured to record data associated with the generation of the epulltab.

11. The system of claim 1, wherein the portal system is further configured to record data associated with activity associated with the epulltab.

12. The system of claim 1, wherein the portal system is further configured to invalidate the epulltab based on a mismatch between the first information and the stored value.

13. The system of claim 12, wherein the portal system is configured to invalidate by presenting a message to a vendor that payout of the win code is disallowed.

14. A method, comprising:
receiving an encrypted code or bar code associated with an epulltab;
extracting first information from the encrypted code or the bar code;
comparing at least a portion of the first information with a value stored in a remote data structure; and
determining whether to validate the epulltab based on the comparison.

15. The method of claim 14, wherein extracting comprises either decoding the bar code scanned by a first device to obtain the encrypted code, and decrypting the encrypted code, or decrypting the encrypted code that is entered manually by a user at the first device.

16. The method of claim 14, wherein comparing comprises comparing a batch number associated with the first information with the stored value, the stored value comprising one of a plurality of stored values uniquely assigned to a vendor associated with the first device.

17. The method of claim 14, further comprising validating the epulltab responsive to matching the portion of the first information with the stored value or invalidating the epulltab when there is no match.

18. A system, comprising:
an epulltab, the pull tab comprising a paper tab with an adhesive layer that obscures first information when unpeeled, wherein the first information comprises a win code, an encrypted code having second information corresponding to a payout value for the win code and identifying information to uniquely identify the epulltab, the identifying information comprising a batch number and a tab number, wherein the first information further comprises a bar code corresponding to the encrypted code.

19. The system of claim 18, further comprising a first device configured to run an interactive game, the interactive game enabled based on decrypting the encrypted code entered at the first device or based on decoding the bar code and decrypting the result of the bar code.

20. The system of claim 18, further comprising a portal system configured to validate the epulltab by receiving the encrypted code or the bar code, extracting information from the encrypted code or the bar code, and comparing a portion of the first information with a value stored in a remote data structure.
